(19) United States
(12) Patent Application Publication
(10) Pub. No.: US 2025/0154028 A1
(43) Pub. Date: May 15, 2025

(54) DISINFECTION REACTOR WITH SPIRAL FLOW

(71) Applicant: TROJAN TECHNOLOGIES GROUP ULC, London (CA)

(72) Inventors: Michael SASGES, British Columbia (CA); John VAREKA, London (CA); Ana-Maria BOGATAN, Waterloo (CA)

(73) Assignee: TROJAN TECHNOLOGIES GROUP ULC, London (CA)

(21) Appl. No.: 18/388,361

(22) Filed: Nov. 9, 2023

(51) Int. Cl. C02F 1/32

(52) U.S. Cl. CPC C02F 1/32; C02F 2201/002; C02F 2201/322

(57) ABSTRACT

An apparatus for disinfecting fluid flowing through a reactor with ultraviolet (UV) light emitted from a light source assembly. The apparatus includes a housing, light source, inlet, and outlet. The inlet and the outlet are positioned on the housing such that flow of fluid through the housing creates a spiral flow path. In an embodiment, the outlet is located in an outer half of the radius of the housing and directs the flow of the fluid into the housing in a direction circumferential with respect to a cylindrical wall of the housing.

### TECHNICAL FIELD

This application relates to an apparatus for treating fluids with ultraviolet light.

### BACKGROUND

Proper disinfection of water is critical to ensure water quality. As the need for cleaner sources of water has increased, water disinfection methods have evolved to match the rising challenge. Water sources may contain heavy metals, sediment, chemicals, pesticides, or the like. Water sources may also contain pathogens such as microorganisms, viruses, or the like. Left untreated, such water may be unhealthy or unsafe for use by humans or animals. Ultraviolet light treatment of water may be used to inactivate pathogens. Water may pass through a small chamber or a larger vessel, known as a reactor, where the water is subjected to ultraviolet light. The ultraviolet treatment may damage nucleic acids of the pathogens making the pathogens incapable of performing vital cellular functions, thereby rendering them harmless. Thus, this ultraviolet treatment process can make water potable despite the water source containing microorganisms, viruses, or the like.

In a reactor used for ultraviolet treatment, the optical absorbance, combined with the discrete locations of sources of the ultraviolet light, can result in non-uniform radiation distribution. As a result, the reactor may not be able to deliver the same dosage of radiation to all of the fluid elements. This problem has been addressed by using mixers that disrupt the flow with the objective of combining flow from regions receiving a high dosage of ultraviolet light and regions receiving a low dosage of ultraviolet light, thereby resulting in the net dosage of the ultraviolet light being the same for all pathways throughout the reactor. Mixers are known to be physical devices, such as metal discs or twisted metal elements. However, these elements block flow, absorb energy, and may catch suspended material in the flow.

Helical reactors using coiled tubing have also been used to induce Dean vortices to mix fluid. However, these reactors have the downsides such as restricted volume, high pressure drop, and a large surface area. There have also been attempts to create helical flow by orientating inlets and outlets tangentially on an annular reactor, sometimes including helical corrugations on the reactor wall. These designs have failed because the viscous forces dampen out the helical flow.

There is a need for an apparatus that can achieve mixing of fluid in an ultraviolet reactor while avoiding the above-discussed downsides of creating helical flow.

### SUMMARY

These and other problems are addressed by the disclosed apparatus for mixing fluid being treated, the fluid flowing through a reactor and being exposed to ultraviolet (UV) light emitted from a UV light source assembly.

The apparatus includes: a cylindrical housing; a light source, being attached to a first end or a second end of the housing, and having a longitudinal axis parallel to a longitudinal axis of the cylindrical housing; an inlet being attached to the first end or the second end of the cylindrical housing, flow of fluid entering the apparatus through the inlet; an inlet diffusion tube that is attached to the inlet and receives the flow of fluid from the inlet, the inlet diffusion tube including one or more slots for delivering the flow of fluid into the housing; and an outlet being attached to the first end or the second end of the cylindrical housing, flow of the fluid out of the housing flowing through the outlet. The inlet is located in an outer half of the radius of the housing, the outlet and the light source are located within an inner half of the radius of the housing, and the one or more slots of the inlet diffusion tube are facing a direction tangential to the housing such that the fluid flows into the housing to create a spiral flow in the housing.

### BRIEF DESCRIPTION OF THE OF THE DRAWINGS

FIG. 1 is a perspective view of a fluid treatment apparatus.

FIG. 2 is a cross-sectional view of the fluid treatment apparatus.

FIG. 3 is a perspective view of a UV lamp that schematically shows emitted UV light.

FIG. 4 is a partial perspective view of a reactor that schematically shows a spiral flow path and secondary flow created by the spiral flow.

FIG. 5 is a cross-sectional view of the fluid treatment apparatus in an alternative configuration.

### DETAILED DESCRIPTION

In the following description, numerous details are set forth to provide an understanding of the present disclosure. However, it may be understood by those skilled in the art that the apparatus of the present disclosure may be practiced without these details and that numerous variations or modifications from the described embodiments may be possible.

Disclosed herein is a fluid treatment apparatus for treating a fluid that flows through the apparatus and is exposed to UV light emitted from a UV light source assembly.

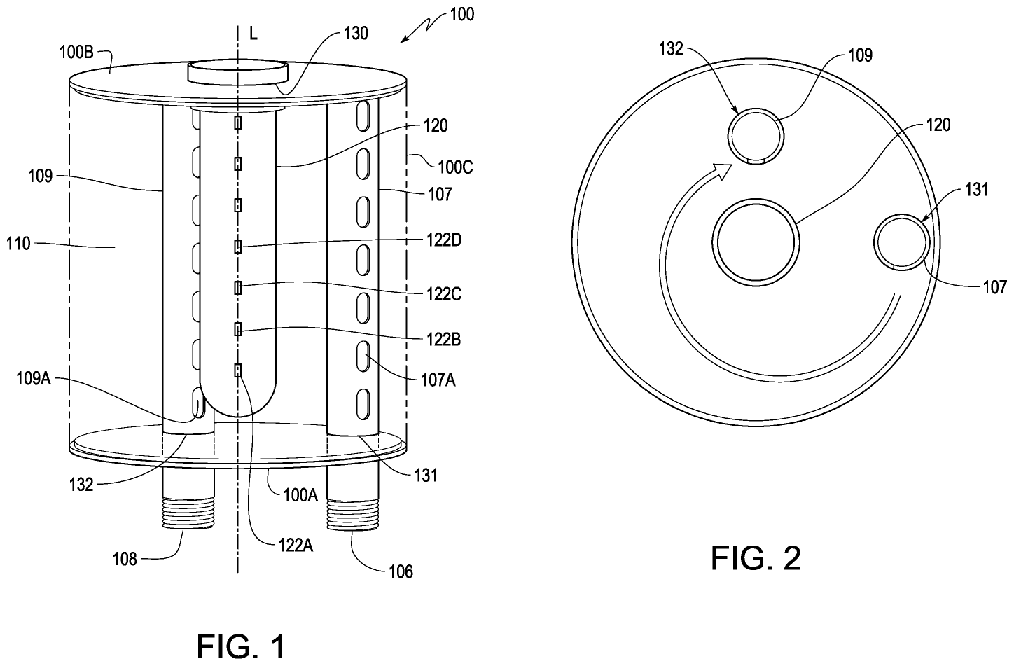

FIG. 1 shows a perspective view of an exemplary apparatus, being a reactor 100, and FIG. 2 shows a cross-sectional view of the reactor 100. As shown in FIGS. 1 and 2, the reactor 100 includes a treatment chamber 110 for receiving a flow of fluid for UV radiation treatment. The treatment chamber 110 extends along a longitudinal axis L and includes an inlet 106 through which fluid is introduced into the treatment chamber 110, an outlet 108 through which the fluid is discharged from the treatment chamber 110 after being treated, and a light source assembly 120 for treating the fluid with UV radiation. The longitudinal axis L may coincide with a longitudinal axis of the reactor 100. The inlet 106 and the outlet 108 may be arranged on the same side of the treatment chamber 110 along the longitudinal axis L. The inlet 106 and outlet 108 are in fluid communication with the treatment chamber 110, and the fluid may flow within the treatment chamber 110 from the inlet 106 to the outlet 108 generally along a radius of the treatment chamber and the longitudinal axis L of the treatment chamber 110. The arrangement of the inlet 106 and the outlet 108 on the treatment chamber 110 is such that the flow of the fluid between the inlet 106 and the outlet 108 travels along a spiral flow path. Further details regarding this arrangement and the creation of the spiral flow path are discussed in further detail below.

Referring to FIG. 1, the reactor 100 may have a cylindrical cross-section shape including two surfaces, surface 100A and surface 100B, at each end of the reactor 100. However, the present disclosure is not limited to any particular cross-sectional shape, and may have any suitable shape, including but not limited to, cylindrical, conical, frustoconical, cubical, rectangular, or the like. The surface 100A of the reactor 100 may include a hole 130 to accommodate a UV light source and the surface 100B of the reactor 100 and may include two holes 131 and 132 to accommodate the inlet 106 and outlet 108 respectively. In an alternative embodiment, the surface 100B of the reactor 100 may include only one hole 131. The holes 130-132 may be concentric with the longitudinal axis L of the treatment chamber 110 or may be offset from the longitudinal axis L of the treatment chamber 110. As discussed in more detail below, the holes 130-132 in the reactor may be used to couple the inlet 106, the outlet 108, and the light source assembly 120 to the reactor 100. However, the present disclosure is not limited to this, and may include any number of holes, inlets, outlets, and light source assemblies. For example, the reactor 100 may include at least two, at least three, or at least four holes, and up to twenty, up to ten, or up to five holes. The holes may include internal threads designed to threadedly engage with external threads on the inlets, outlets, and light source assemblies. Alternatively, the holes may include any other connecting mechanism suitable for detachably connecting inlets, outlets, and light source assemblies.

In an embodiment, the reactor 100 may be an apparatus for a residential system for disinfecting water for household use. The reactor 100 may be installed between a water source, such as a well or municipal water facility, and the household piping. For example, the reactor 100 may installed at a point of entry of the water into the household piping. The reactor 100 can be integrated into existing piping to treat the fluid flowing through the piping. For example, the inlet 106 and the outlet 108 may be coupled to the piping to provide in-line flow and a simple connection to the household piping without using an L-shape or elbow pipe connector. The reactor 100 may be installed so as to be integrated with the household piping in the basement of a home at a position where the water flowing from external piping in fluid communication with a well or water treatment facility enters the home. The inlet 106 may receive water flowing from the water source, the treatment chamber may treat the water with UV radiation, making the water safe for use, and the outlet 108 may deliver the treated water to downstream household piping for household use. For residential systems, the treatment chamber 110 can have a volume that is in a range of about 0.25 L to 10 L, from 0.5 L to 5 L, or from 1 L to 3 L, for example. The reactor 100 may be designed for a flow of fluid, such as water or other aqueous fluids, through the treatment chamber 110 at a flow rate in a range of 1 to 25 gallons per minute (gpm), 5 to 20 gpm, or 10 to 15 gpm. Of course, at times, the fluid in the reactor 100 may be stagnant, in which case the flow rate may be less than 1 gpm, less than 0.5 gpm, or less than 0.25 gpm.

For residential systems, the reactor 100 may have a length, in a direction along the longitudinal axis L from the inlet 106 to the outlet 108, in a range of 100 mm to 1,000 mm, 200 mm to 500 mm, or 240 mm to 350 mm. The treatment chamber 110 of the reactor 100 may have a diameter or width dimension in a direction orthogonal to the longitudinal axis L in a range of 25 mm to 250 mm, 50 mm to 200 mm, or 75 mm to 150 mm.

In an embodiment, the reactor 100 includes the light source assembly 120 being removably coupled to the reactor 100 via the hole 130. The light source assembly 120 may be arranged inside the treatment chamber 110 to treat the fluid flowing through the treatment chamber 110 with UV radiation for disinfection, purification, sterilization, or the like. The light source assembly 120 is arranged in the treatment chamber 110 based on the location of the hole 130 on the surface 100A. For example, the hole 130 may be positioned on the surface 100A such that it is concentric with the longitudinal axis L of the treatment chamber 110, thereby arranging the light source assembly 120 along the longitudinal axis L of the treatment chamber 110. Alternatively, the center of the hole 130 may be located at a position in an inner half of the radius of the surface 100A, an inner third of the radius of the surface 100A, or an inner fourth of the radius of the surface 100A. Of course, the light source assembly 120 may be attached to the hole 130 on the surface 100A at any suitable location and may be attached to the hole 130 which is located on the surface 100B of the reactor 100 at any suitable location. The light source assembly 120 may have a tubular shape having an outer wall along a longitudinal direction of the light source assembly 120. However, the present disclosure is not limited to any particular cross-sectional shape, and the light source assembly 120 may have various other cross-sectional shapes, for example, an elliptical shape, a polygonal shape including, for example, a square or rectangular shape, and a semicircular shape.

The light source assembly 120 may include a plurality of light source units 122A-122D arranged along the length of the light source assembly 120 on a surface of the light source assembly 120. The light source assembly 120 may have a maximum diameter or width that is less than a quarter of the diameter or width of the treatment chamber 110, less than an eighth of the diameter or width of the treatment chamber 110, or less than a sixteenth of the diameter or width of the treatment chamber 110. The light source assembly 120 may have a diameter that is the same as a diameter of the hole 130. The light source assembly 120 may have a diameter at the connection between the light source assembly 120 with the hole 130 that is larger than a diameter at a longitudinally central position of the light source assembly. The light source assembly 120 may have a diameter that changes along the length of the light source assembly 120. For example, as shown in FIG. 1, the light source assembly 120 may have, at an end of the light source assembly 120 opposite to where the light source assembly 120 is attached to the hole 130 that decreases along the length of the light source assembly 120 to form a rounded end.

The light source units 122A-122D of the light source assembly 120 may span an entire length of the light source assembly 120, half the length of the light source assembly 120, or a quarter of the length of the light source assembly 120. However, the present disclosure is not limited to this arrangement, and the light source units 122A-122D may be arranged in any suitable manner. The light source units 122A-122D may be UV LEDs that are configured to emit UV radiation inside the treatment chamber 110 of the reactor 100. The light source units 122A-122D may emit light in the UV spectrum, for example, in a wavelength band of about 100 nm to about 405 nm, a wavelength band of about 140 to about 330 nm, or a wavelength band of about 180 nm to about 280 nm. The UV light in the above wavelength bands has high germicidal efficacy and may kill at least 99% of microorganisms, such as bacteria, fungi, viruses, mold, and the like, in the fluid, making the fluid safe for use and consumption. The light source units 122A-122D may have an efficiency in converting electrical energy to UV light energy in a range of about 3% to about 30%, a range of about 4% to about 15%, or a range of about 5% to about 10%. The reactor 100 may be designed to deliver a UV dose of 5 mJ/cm2 to 100 mJ/cm2, or about 30mJ/cm2, to the fluid at a target flow rate and target water quality, or may be designed to deliver any other suitable UV dose to the fluid. The light source units 122A-122D may be arranged to emit radiation from the light source unit 120 360° around the light source unit, 180° around the light source unit 120, or 90° degrees around the light source unit 120.

Each of the light source units 122A-122D may include a length dimension that is oriented in the treatment chamber 110 along the longitudinal axis L of the treatment chamber 110 and a thickness dimension that is oriented in the treatment chamber 110 orthogonally to the longitudinal axis L of the treatment chamber 110. The maximum length dimension of each of the light source units 122A-122D may be at least twice that of the thickness dimension of each of the light source units 122A-122D. The maximum length dimension of each of the light source units 122A-122D may be 2 to 20 times larger than the maximum thickness dimension, 3 to 15 times larger than the maximum thickness dimension, or 5 to 10 times larger than the maximum thickness dimension of each of the light source units 122A-122D.

Referring to FIG. 1, the inlet 106 may be coupled to the reactor via hole 131. The inlet 106 may be coupled through the hole 131 to an inlet diffusion tube 107 that extends into the treatment chamber 110 parallel to the longitudinal axis L of the treatment chamber 110 to provide untreated fluid into the treatment chamber 110. The inlet diffusion tube 107 may have a cylindrical shape. The inlet diffusion tube 107 may extend from the hole 131 to the other of the surface 100A or the surface 100B that the hole 131 is arranged. The inlet diffusion tube 107 is arranged in the treatment chamber 110 based on the location of the hole 131. For example, the hole 131 may be positioned at an outer radius of the surface 100A of the reactor 100 such that the inlet diffusion tube 107 is adjacent to an outer wall 100C of the reactor 100. Alternatively, the center of the hole 131 may be located in an outer half of the radius of the surface 100A, an outer third of the radius of the surface 100A, or an outer fourth of the radius of the surface 100A. Of course, the inlet diffusion tube 107 may be attached via the hole 131 which is located on the surface 100A of the reactor 100 at any suitable location or on the surface 100B of the reactor 100 at any suitable location.

In an embodiment, the inlet diffusion tube 107 includes a plurality of slots 107A that the fluid travels through into the treatment chamber 110. As the fluid enters the reactor 100 through the inlet 106, it travels out of each of the slots 107A of the inlet diffusion tube 107. The slots 107A may be arranged along the inlet diffusion tube 107 parallel to the longitudinal axis L of the treatment chamber 110. The inlet diffusion tube 107 may include 3 or more slots, 7 or more slots, 14 or more slots, or a continuous slot extending parallel to the longitudinal axis L of the treatment chamber 110. The slots 107A may be circumferentially positioned in an outer wall of the inlet diffusion tube 107 at any suitable location. For example, the slots 107A may be positioned in the outer wall of the inlet diffusion tube 107 facing a direction perpendicular to a line between the longitudinal axis L of the treatment chamber 110 and a center of the hole 131. Alternatively, the slots 107A may be positioned in the outer wall of the inlet diffusion tube 107 facing a direction parallel to the line between the longitudinal axis L of the treatment chamber 110 and a center of the hole 131. Of course, the slots 107A may be positioned in the outer wall of the inlet diffusion tube 107 facing any suitable direction and some of the slots 107A may face in different directions from other slots 107A. Alternatively, the slots 107A may be perforations in the inlet diffusion tube 107.

The inlet diffusion tube 107 may have diameter that is smaller than the diameter or width of the light source assembly 120, half the diameter or width of the light source assembly 120, or a quarter of the diameter or width of the light source assembly 120. The inlet diffusion tube 107 may have a diameter that is the same as the diameter or width of the light source assembly 120, larger than the diameter or width of the light source assembly 120, or double the diameter or width of the light source assembly 120.

Referring to FIG. 1, the outlet 108 may be coupled to the reactor via hole 132. Similar to the inlet 106, outlet 108 may be coupled through the hole 132 to an outlet diffusion tube 109 that extends into the treatment chamber 110 parallel to the longitudinal axis L of the treatment chamber 110 to receive treated fluid from the treatment chamber 110. The outlet diffusion tube 109 may have a cylindrical shape. The outlet diffusion tube 109 may extend from the hole 132 to the other of the surface 100A or the surface 100B that the hole 132 is arranged in. The outlet diffusion tube 109 is arranged in the treatment chamber 110 based on the location of the hole 132. For example, the hole 132 may be positioned in an inner half of the radius of the surface 100A, an inner third of the radius of the surface 100A, or an inner fourth of the radius of the surface 100A. Of course, the outlet diffusion tube 109 may be attached via the hole 132 which is located on the surface 100A of the reactor 100 at any suitable location or on the surface 100B of the reactor 100 at any suitable location.

In an embodiment, the outlet diffusion tube 109 includes a plurality of slots 109A that the fluid travels through out of the treatment chamber 110. As the fluid travels through the treatment chamber 110, it travels into each of the slots 109A of the outlet diffusion tube 109 such that the treated fluid is delivered to the outlet 108. The slots 109A may be arranged along the outlet diffusion tube 109 parallel to the longitudinal axis L of the treatment chamber 110. The outlet diffusion tube 109 may include 7 or more slots, 14 or more slots, or a continuous slot extending parallel to the longitudinal axis L of the treatment chamber 110. The slots 109A may be circumferentially positioned in an outer wall of the outlet diffusion tube 109 at any suitable location. For example, the slots 109A may be positioned in the outer wall of the outlet diffusion tube 109 facing a direction perpendicular to a line between the longitudinal axis L of the treatment chamber 110 and a center of the hole 132. Alternatively, the slots 109A may be positioned in the outer wall of the outlet diffusion tube 109 facing a direction parallel to a line between the longitudinal axis L of the treatment chamber 110 and a center of the hole 132. Of course, the slots 109A may be positioned in the outer wall of the outlet diffusion tube 109 facing any suitable direction and some of the slots 109A may face in different directions from other slots 109A. Alternatively, the slots 109A may be perforations in the outlet diffusion tube 109.

As shown in FIG. 2, the fluid flows into the treatment chamber from the inlet 106 to the outlet 108. The direction of the fluid flow is determined based on the respective locations of the inlet 106 and the outlet 108, which are based on the respective locations of the holes 131 and 132. The direction of the fluid flow may also depend on the location of the light source assembly, which depends on the location of hole 130.

Referring to FIG. 2, the orientation of hole 131 and hole 132 may be at different circumferential positions relative to a line from the longitudinal axis L of the treatment chamber 110 to a position on the outer wall 100C of the treatment chamber 110. For example, as shown in FIG. 2, hole 132 is approximately at a 12 o′clock position, relative to the line from the longitudinal axis L of the treatment chamber 110 to the position on the outer wall 100C of the reactor 100 and hole 131 is approximately at a 3 o′clock position, relative to the line from the longitudinal axis L of the treatment chamber 110 to the position on the outer wall 100C of the reactor 100. Of course, the positions of holes 131 and 132 may be at any location relative to the outer wall 100C of the reactor 100. The center of hole 131 and the center of hole 132 may be oriented such that an angle between (i) a radial line from the longitudinal axis L of the treatment chamber 110 to the center of hole 131 and (ii) a radial line from the longitudinal axis L of the treatment chamber 110 to the center of hole 132 is in a range of 20° to 180°, a range of 50° to 150°, or a range of 80° to 100°. However, this angle may be in any suitable range.

A distance between the outlet diffusion tube 109 and the light source assembly 120 may be less than a distance between the inlet diffusion tube 107 and the light source assembly 120, half the distance between the inlet diffusion tube 107 and the light source assembly 120, or a quarter of the distance between the inlet diffusion tube 107 and the light source assembly 120.

In an alternative embodiment, the reactor 100 does not include the outlet diffusion tube 109 and the light source assembly 120 may be attached directly to the outlet 108. Accordingly, the treatment chamber 110 may include only two holes, 130 and 131, and the outlet 108 is attached to the hole 130 for the fluid flow to exit. In this embodiment, the light source assembly 120 may include an aperture 120A for fluid to flow into and the fluid flows through the light source assembly 120 to exit through the outlet 108. The aperture 120A may be, for example, a slot along the longitudinal direction of the light source assembly 120. The present embodiment is not limited to this configuration and the light source assembly 120 may include other channels for the fluid flow to travel into such that the fluid exits the outlet 108. For example, the light source assembly 120 may include holes, a mesh, or any other suitable type of channel.

In the alternative embodiment, the fluid flow through the light source assembly 120 may be directed to travel across any or all of the light source units 122A-122D. The temperature of the fluid flow may be a lower temperature than a temperature of the light source units 122A-122D and therefore the fluid flow that contacts the light source units 122A-122D may be used to cool the light source units 122A-122D.

In another alternative embodiment, the reactor 100 does not include the inlet diffusion tube 107 and outlet diffusion tube 109. In this embodiment, the fluid flow travels through the inlet 106, directly into the treatment chamber 110, and out of the treatment chamber through the outlet 108.

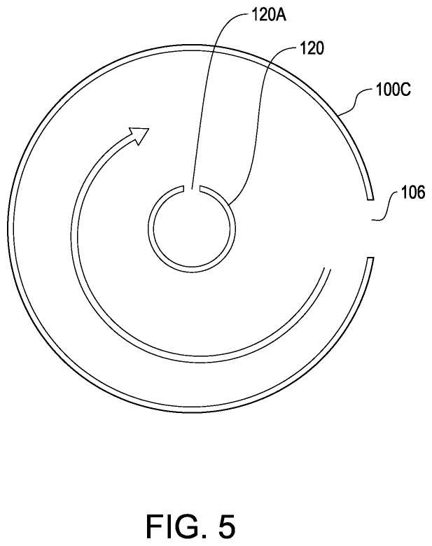

In other embodiments, the reactor 100 does not include one or both of the inlet diffusion tube 107 and outlet diffusion tube 109, and the surface 100B or the surface 100A optionally does not include hole 131 for the inlet 106. Rather, referring to FIG. 5, the inlet 106 of the reactor 100 can be an opening in the outer wall 100C of the reactor 100. In other embodiments, the light source assembly 120 may include the aperture 120A such that the fluid flows through the light source assembly 120 to exit the reactor. In general the location and orientation of either or both of the inlet and the outlet of the reactor are not particularly limited so long as they are arranged to provide the desired type of fluid flow in the reactor, e.g., substantially circumferential flow that spirals from an initial flow with larger radius to a flow with tighter radius of curvature.

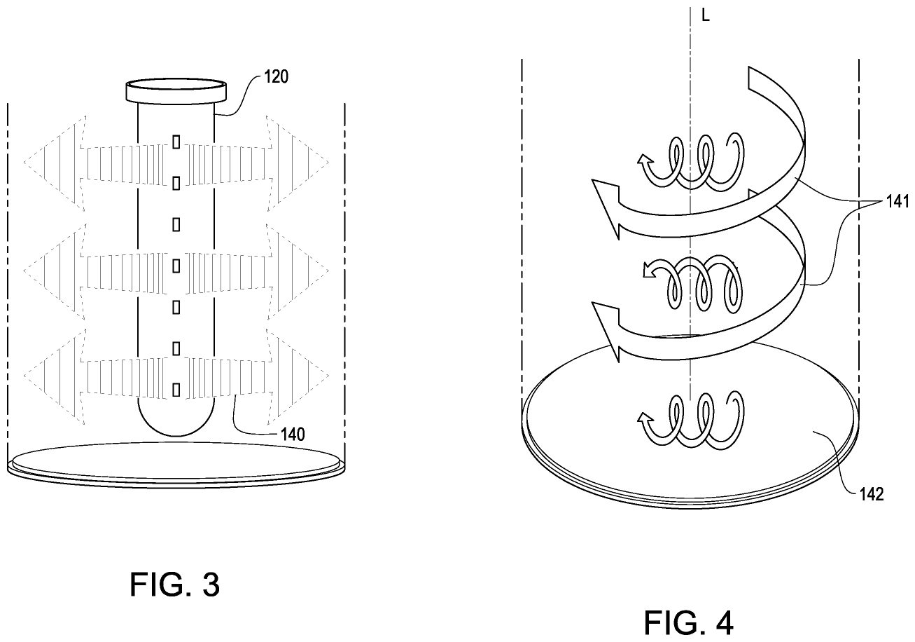

Referring to FIG. 3, during use, the light source assembly 120 delivers a UV dose and the fluid that is closest to the light source assembly 120 receives the highest amount of the UV dose. For example, the UV dose at a position radially inward of a radially outward position may create a UV gradient 140 throughout the treatment chamber 110. As the fluid flow travels through the treatment chamber 110, the amount of UV dose that an individual element of the fluid flow receives depends on where the individual element is located in the UV gradient 140. As a result, a pathway of an individual fluid flow element through the treatment chamber 110 determines for how long the individual fluid element is in a region of the UV gradient 140, thereby determining the amount of UV dosage each individual fluid element receives as it travels from the inlet 106 to the outlet 108. For example, a fluid element that enters through the inlet 106 and travels along an outer radial portion of the treatment chamber 110 to reach the outlet 108 will receive less UV dosage than a fluid element that enters through the inlet 106 and travels along an inner radial portion of the treatment chamber 110 to reach the outlet 108. By arranging the inlet 106 and outlet 108 to change the pathway of the fluid flow through the treatment chamber 110, the amount of UV dosage the reactor 100 delivers to each of the UV elements is made more uniform.

For example, in an embodiment, the UV dosage delivered to each of the individual fluid elements is made uniform by creating a spiral flow path 141 in the treatment chamber 110 of the reactor 100. As an example, this spiral flow path 141 may be achieved by positioning the inlet 106 radially outward of the outlet 108, such that when the fluid flows from the inlet 106 to the outlet 108, centrifugal force developed by the radius of the flow decreasing toward an axial exit results in the spiral flow path 141 and fluid flow instability that results in development of secondary vortices 142 of the fluid flow. These phenomena result in fluid traveling between regions of higher UV dosage and regions of lower dosage so as to uniformly distribute the amount of UV dosage to each individual fluid element and are described in more detail below.

As discussed above, the inlet diffusion tube 107 may be oriented such that its slots 107A are positioned in the outer wall of the inlet diffusion tube 107 facing a direction perpendicular to a line between the longitudinal axis L of the treatment chamber 110 and a center of the hole 131. In other words, the slots 107A may be facing a direction that is parallel to a direction tangential to the circumference of the treatment chamber 110 (or in a generally circumferential direction with respect to a cylindrical housing). As a result, as individual fluid elements of the fluid flow exiting the inlet diffusion tube 107 through slots 107A, the individual fluid elements initially travel in the direction tangential to the circumference of the treatment chamber 110. Meaning, the individual fluid elements enter the treatment chamber 110 with angular momentum and angular velocity, relative to the treatment chamber, and specifically relative to the longitudinal axis L of the treatment chamber 110. Conservation of this angular momentum causes the spiral flow path 141 to develop, as discussed below.

As the fluid flow moves from the radially outward position at the inlet diffusion tube 107 to the radially inward position at the outlet diffusion tube 109, the angular momentum relative to the longitudinal axis L of the treatment chamber 110 is conserved such that the fluid flows at an angle relative to a straight path between the inlet diffusion tube 107 and the outlet diffusion tube 109. As fluid flow continues to enter the treatment chamber 110, conservation of the angular momentum as the fluid flows radially inward causes the fluid flow to rotate about the longitudinal axis L of the treatment chamber 110 and the spiral flow path 141 forms. The spiral flow path 141 is characterized in that as the flow moves radially closer to the outlet diffusion tube 109, the circumference about which the flow rotates relative to the longitudinal axis L of the treatment chamber 110 becomes smaller. As a result, the angular velocity of individual fluid elements along the spiral flow path 141 at a radially outward position, near the inlet 106 will have a smaller angular velocity than individual fluid flow elements at a position radially inward position, near the outlet diffusion tube 109.

The creation of the spiral flow path 141 may be used to improve the uniformity of the UV dosage delivered to the individual fluid elements and is further improved by creating secondary vortices 142. As discussed above, in the creation of the spiral flow path 141 is associated with the angular velocity of the fluid flow exiting through the outlet 108 is higher than the fluid flow entering through the inlet 106 and the fluid flow at radially inward positions having higher angular velocity than fluid flow at radially outward positions. Meaning, the angular velocity individual elements of the fluid flow at any position within the treatment chamber 110 may be based on a distance between that position and the longitudinal axis L of the treatment chamber 110. For example, the angular velocity of the fluid flow at the position which is furthest from the longitudinal axis L of the treatment chamber 110 may be lowest and the fluid flow nearest to the longitudinal axis L of the treatment chamber 110 or the outlet diffusion tube 109 may be highest. Referring to FIG. 4, the difference in the angular velocity of the fluid flow between radially inward and radially outward positions causes regions of secondary vortices 142 as the faster moving fluid flow attempts to exit through the outlet 108. These secondary vortices 142 further mix the fluid flow such that the individual elements of the fluid flow move and in and out of regions near the light source assembly 120 in which the UV dosage is higher. The additional mixing caused by the secondary vortices 142 results in the overall fluid flow receiving a more uniform UV dosage.

In an embodiment, the above-discussed spiral fluid flow is achieved without the inlet diffusion tube 107 or the outlet diffusion tube 109. The above-described phenomenon similarly occurs when the fluid flows out of the inlet 106, directly into the treatment chamber 110 at a radially outer position, and into the outlet 108 at a radially inner position. The flow geometry upstream of inlet 106 or the shape of inlet 106 may be configured to impart a flow direction that is largely tangential to the outer wall 100C, providing the fluid with angular momentum relative to the chamber.

Although embodiments disclosed herein have been described with respect to treating water and/or aqueous fluids with UV radiation treatment, the present disclosure is not limited to water and aqueous fluids, and may be used to treat any fluid, including liquids, vapors, gels, plasmas, and gases. Similarly, the present disclosure is not limited to residential UV treatment systems, and may be applied to industrial, municipal, and commercial systems.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. An apparatus for disinfecting fluid comprising:
a cylindrical housing;
a light source, being attached to a first end or a second end of the housing, and having a longitudinal axis parallel to a longitudinal axis of the housing;
an inlet being attached to the first end or the second end of the housing, flow of fluid entering the apparatus through the inlet;
an inlet diffusion tube that is attached to the inlet and receives the flow of fluid from the inlet, the inlet diffusion tube including one or more slots that the flow of the fluid travels through into the housing; and
an outlet being attached to the first end or the second end of the housing, flow of the fluid out of the housing flowing through the outlet, wherein:
the inlet is located in an outer half of a radius of the housing,
the outlet and the light source are located in an inner half of the radius of the housing, and
the one or more slots of the inlet diffusion tube faces a direction tangential to the housing such that the flow of the fluid out of the one or more slots creates a spiral flow path of the fluid in the housing to the outlet.

2. An apparatus for disinfecting a fluid comprising:
a cylindrical housing that has a cylindrical wall, a first end wall, and a second end wall, the cylindrical housing comprising:
(i) an inlet that directs the fluid flowing into the cylindrical housing in a generally circumferential direction with respect to the cylindrical wall;
(ii) an outlet through which the fluid exits the cylindrical housing; and
a light source that extends along a longitudinal axis of the cylindrical housing and is configured to direct light into the fluid when it is within the cylindrical housing.

3. The apparatus for disinfecting a fluid according to claim 2, wherein the outlet is located at the first end wall of the housing.

4. The apparatus for disinfecting a fluid according to claim 3, wherein the light source is located at the center of the housing and extends from the first end wall of the housing to the second end wall of the housing.

5. The apparatus for disinfecting a fluid according to claim 2, wherein the light source includes one or more apertures that are connected to the outlet so that the fluid flows through the apertures and out of the outlet.
